(19) United States
(12) Patent Application Publication
(10) Pub. No.: US 2014/0289712 A1
(43) Pub. Date: Sep. 25, 2014

(54) Effective Lifetime Dependency Analysis and Typestate Analysis

(71) Applicant: NEC Laboratories America, Inc., Princeton, NJ (US)

(72) Inventors: Aarti Gupta, Princeton, NJ (US); Gogul Balakrishnan, Princeton, NJ (US); Franjo Ivancic, Princeton, NJ (US); Xusheng Xiao, Raleigh, NC (US)

(73) Assignee: NEC Laboratories America, Inc., Princeton, NJ (US)

(21) Appl. No.: 14/199,036

(22) Filed: Mar. 6, 2014

Related U.S. Application Data
(60) Provisional application No. 61/803,697, filed on Mar. 20, 2013.

(51) Int. Cl. G06F 11/36

(52) U.S. Cl. CPC G06F 11/3608
USPC 717/132; 717/131

(57) ABSTRACT

Disclosed are typestate and lifetime dependency analysis methods for identifying bugs in C++ programs. Disclosed are an abstract representation (ARC++) that models C++ objects and which makes object creation/destruction, usage, lifetime and pointer operations explicit in the abstract model thereby providing a basis for static analysis on the C++ program. Also disclosed is a lifetime dependency analysis that tracks implied dependency relationships between lifetimes of objects, to capture an effective high-level abstraction for issues involving temporary objects and internal buffers, and subsequently used in the static analysis that supports typestate checking for the C++ program. Finally disclosed a framework that automatically genarates ARC++ representations from C++ programs and performs typestate checking to detect bugs that are specified as typestate automata over ARC++ representations.

### TECHNICAL HELD

This disclosure relates generally to the field of computer software systems and in particular to methods for the effective typestate and lifetime dependency analysis of software systems such as those written in C/C++.

### BACKGROUND

As is known, object oriented languages including Java and C++ are now extensively used to construct large-scale software and systems. As contemporary society increasingly relies on such software and systems, scalable techniques for checking the correctness, reliability and robustness of such software and systems becomes increasingly important. And while a number of scalable static analysis techniques for C and Java have been proposed, there has been comparatively little work done on the static analysis of C/C++ programs. Consequently the development of such techniques would represent a welcome addition to the art.

### SUMMARY

An advance is made in the art according to an aspect of the present disclosure directed to methods that identify correctness, performance, and maintenance issues (bugs) in C++ programs using bug patterns. Advantageously, a pattern-based method according to the present disclosure using simple patterns may detect even complex bugs involving lifetimes of objects.

Viewed from one aspect, the present disclosure is directed to typestate and lifetime dependency analysis methods for identifying bugs in C++ programs. Disclosed are an abstract representation (ARC++) that models C++ objects and which makes object creation/destruction, usage, lifetime and pointer operations explicit in the abstract model thereby providing a basis for static analysis on the C++ program. Also disclosed is a lifetime dependency that tracks implied destructions between objects such that an effective high-level abstraction for issues involving temporary objects and internal buffers and subsequently used in the static analysis that supports typestate checking for the C++ program. Finally disclosed a framework that automatically genaerates ARC++ representations from C++ programs and performs typestate checking to detect bugs that are specified as typestate automata over ARC++ representations.

### BRIEF DESCRIPTION OF THE DRAWING

A more complete understanding of the present disclosure may be realized by reference to the accompanying drawings in which:

FIG. 1 is a schematic diagram of an exemplary general purpose computer programmed to execute a method according to the present disclosure to find and correct a computer program;

FIG. 2 is a schematic diagram showing a generic high-level abstract retation based program analysis according to an aspect of the present disclosure;

FIG. 3 is a schematic diagram showing a number of main components employed duding abstract interpretation according to an aspect of the present disclosure; and

FIG. 4 is a schematic diagram showing a high-level overview of a tool chain according to an aspect of the present disclosure.

### DETAILED DESCRIPTION

The following discussion and attached Appendix merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we note that as contemporary software development has increased a need for higher levels of abstractions in the software development industry, software programming teams have significantly shifted programming languages used to object-oriented languages such as Java or C++. The benefits of using an object-oriented language are well known and include—among others—maintainability, encapsulation, and inheritance. Despite the use of such languages however, it is nevertheless becoming more difficult to test and debug software due to large code bases and increasing complexity.

Whereas, a large volume of work on verification has focused on C programs or Java programs, there has been comparatively little work on the verification of C++ programs. C++ has a number of distinguishing features that makes it difficult and—in some cases—impossible to use the verification techniques developed for other languages such as C and Java.

More particularly, C++ is deliberately chosen for a software project due to its ability to fully interact with legacy C-based systems, including system-level, C-based, application programming interfaces (APIs). Therefore, development in C++ necessitates a mixed programming style combining features of high-level object-oriented constructs and lower-level C-based code. Moreover, the semantics of inheritance, virtual-function dispatch, and exceptions are different from other object-oriented languages such as Java. Consequently, there is a need to develop methods for the automatic verification and testing targeted at C++ programs.

According to an aspect of the present disclosure, an algorithm is disclosed to find typical correctness, performance, and maintenance issues in C++ programs using bug patterns. As used herein, bug patterns are code idioms that are likely to be errors and describe coding practices that arise from misunderstanding of the language semantics, or simple and common mistakes. For example, absence of a copy constructor when the associated class has pointer fields is typically a bug. Similarly, dereferencing a Standard Template Library (STL) iterator without checking that it is not pointing within iterator bounds is most probably a bug. To find such bugs, our disclosure presents a framework for developers to specify bug patterns and disclose further a static analysis method to automatically detect the presence of such bug patterns in a software program.

As may be readily appreciated by those skilled in the art, one of the peculiarities of C++ semantics is related to the lifetime(s) of temporary objects. More particularly, in C++, temporary objects are often created by a compiler and cause performance and correctness issues that are hard to find and understand.

As is generally understood, temporary objects are unnamed objects created on a stack by the compiler. They are used during reference initialization and during evaluation of expressions including standard type conversions, argument passing, function returns, and evaluation of the throw expression. Performance bottlenecks can arise through the necessary creation and destruction of such temporary objects. Correctness issues can arise due to the complex lifetime semantics of temporary objects often leading to accesses of previously freed/destructed memory.

The use of a mixed C and C++ programming (programs comprising both C and C++ programming) links the lifetimes of objects in complex ways. For example, consider a class that has a method ‘foo’ that returns an internal buffer and another method ‘bar’ that possibly reallocates the same internal buffer. Incorrect interactions of ‘foo’ and ‘bar’ can result in use-after-free errors.

As we shall disclose, our pattern-based bug detection framework can advantageously detect even complex bugs involving lifetimes of objects using simple patterns. As noted above, temporary objects have an impact both on correctness and performance, and mixed C+ and C++ programming links object lifetimes in complex ways.

Generally, the correctness issues related to object lifetimes are hidden during testing due—in part—to the fact that stale uses of object storage often occurs shortly after destruction of the object. Nevertheless, in an actual deployed production environment such short-term stale uses cause hard to find runtime errors, and memory corruption, leading to memory faults in the future. Furthermore, such memory corruption can also potentially be exploited by malicious user

According to the present disclosure, a bug pattern is provided as a finite state machine (FSM) with a designated error state that is only reachable in the FSM for buggy code patterns. The finite state machine formalism is used fir this purpose. To make it easy to specify bug patterns, we annotate the given program with several high level notions such as ObjectCreation, ObjectDestruction, etc. We refer to these abstractions or annotations as ARC++.

For the given bug pattern, we perform a call-summary-based static analysis that computes the set of reachable FSM states for each point in the program. Static analysis consists of a number of stages that are required for solving the problem.

First, we need a finite representation for the potentially infinite set of heap and stack objects during static analysis. To this end, we describe an object abstraction based on access paths in the program and a notion of object clusters. As used herein, access paths correspond to the data access expressions in a C++ program. An object cluster represents a set of concrete objects that are potentially abased to each other.

In some cases, the bug pattern may involve objects of more than one type. In such cases, we have defined a dependency graph that links objects that are related by the bug pattern. That is, an edge in the dependency graph between object o and p means that the state of one object is dependent on the other. Based on this notion, we build method summaries, where the behavior of methods and their side-effects on parameters and globals with respect to dependencies is captured.

Subsequently, we perform a call-summary-based program analysis based on the object abstraction and dependency graph (if needed) and compute an over-approximation for the set of FSM states that are reachable at every program point. If any program point contains the error state, then it is reported to the user.

One particularly interesting aspect of the present disclosure is observed is when the tracked dependency is related to the lifetime of objects. In such cases, if an operation, modification or destruction of object o causes the lifetime to expire for Object p, we introduce special liftetime dependency edges. Advantageously, these can be used to easily discover stale uses of objects after their lifetime has expired due to a modification of another object.

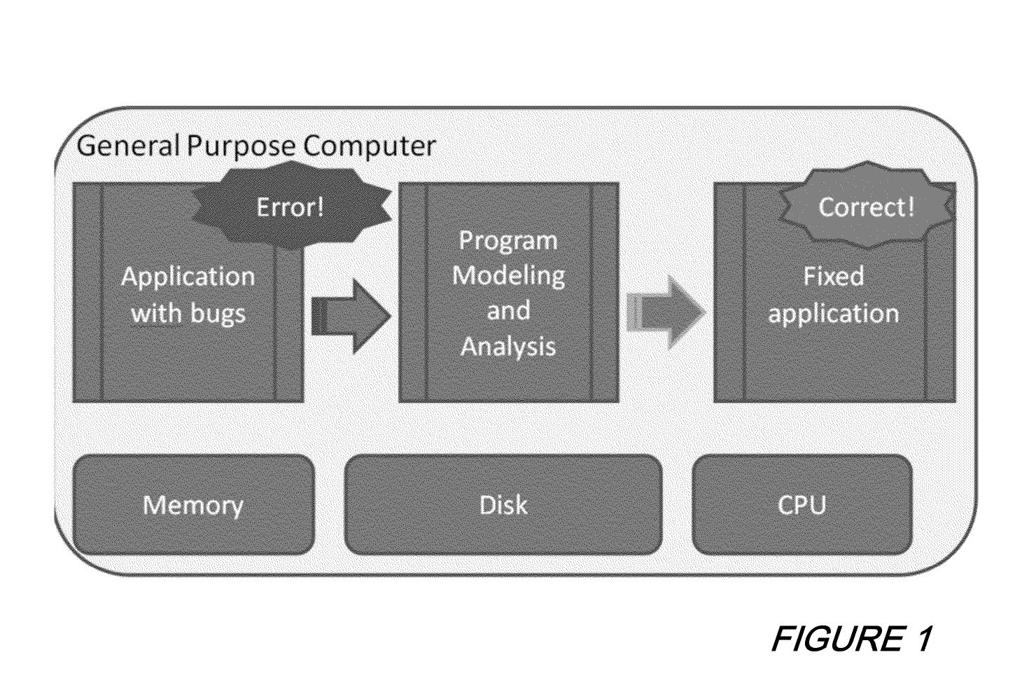

Turning now to FIG. 1, there is shown in schematic block diagram form a general purpose computer which may be programmed to perform a method according to the present disclosure. Advantageously such methods are automated such that a computer program may be automatically analyzed such that a determination as to whether or not the computer program is correct—or not (contains bugs). Should such analysis determine faulty behavior(s), then such behavior(s) may be removed from the program resulting in its correct execution.

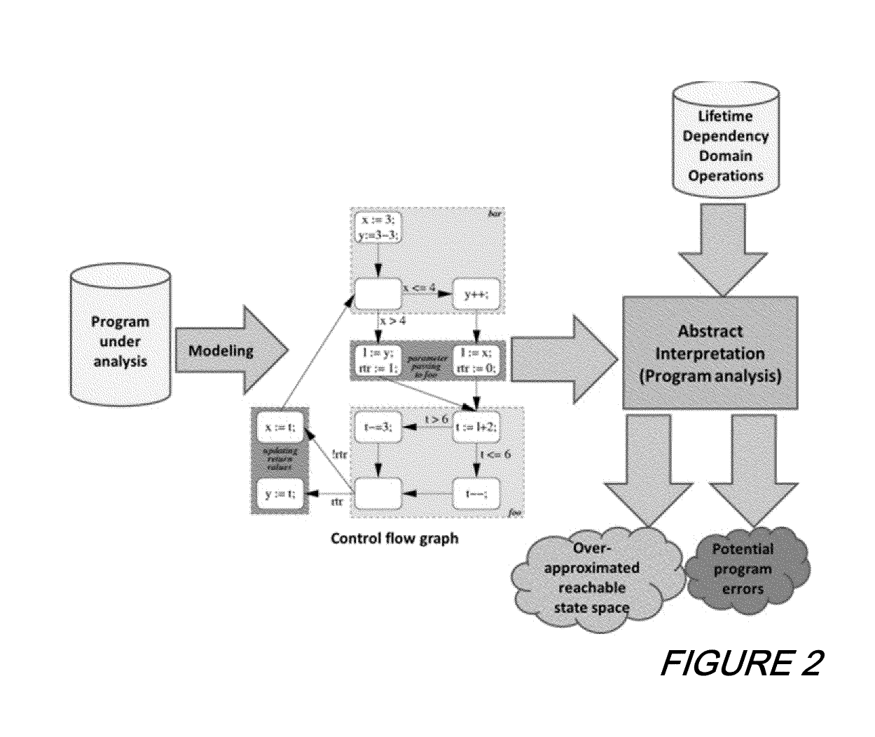

According to the present disclosure, an abstract interpretation is performed and is shown schematically in FIG. 2. As is known, abstract interpretation is a well-known and understood technique to enable an efficient static program analysis. Abstract interpretation computes an over-approximation of reachable states—that is it computes a set of states which contains only those states that may be reached when the program is executed. This can be used to highlight potential errors in the program such as null-pointer accesses, buffer overruns, division-by-zero, etc.

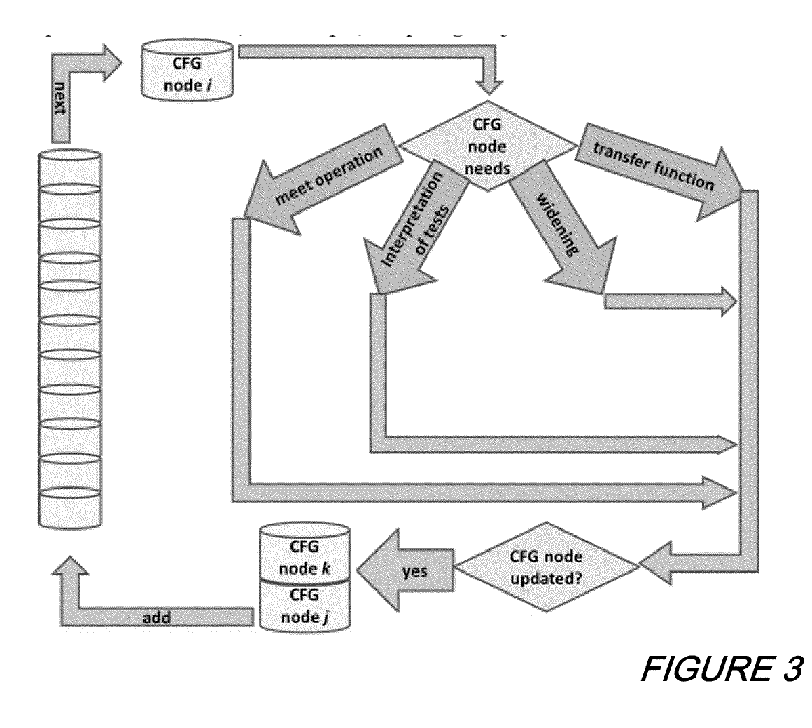

With reference now to FIG. 3, there is shown a schematic diagram which highlights some of the main components of a method according to the present disclosure. As depicted in that figure, the abstract interpretation technique maintains a work queue of control flow graph (CM) nodes that need to be further processed. For each CFG node, one of the following operations is generally performed: update a lattice element using a transfer function based on the assignments in the CFG node, perform a meet operation of two lattice elements, if the CFG node has multiple incoming parent nodes, perform widening of the lattice element in order to guarantee termination due to loops, or check whether a condition is potentially satisfied at the current node (interpretation of tests). After the operation has taken place, and if an update to the lattice element has occurred, the child CFG nodes may be added to the work-queue for additional processing. Notably a number of commonly used operations are not shown explicitly in FIG. 3 to avoid unnecessarily cluttering that figure. Items not included for example, include computing the join of two lattice elements.

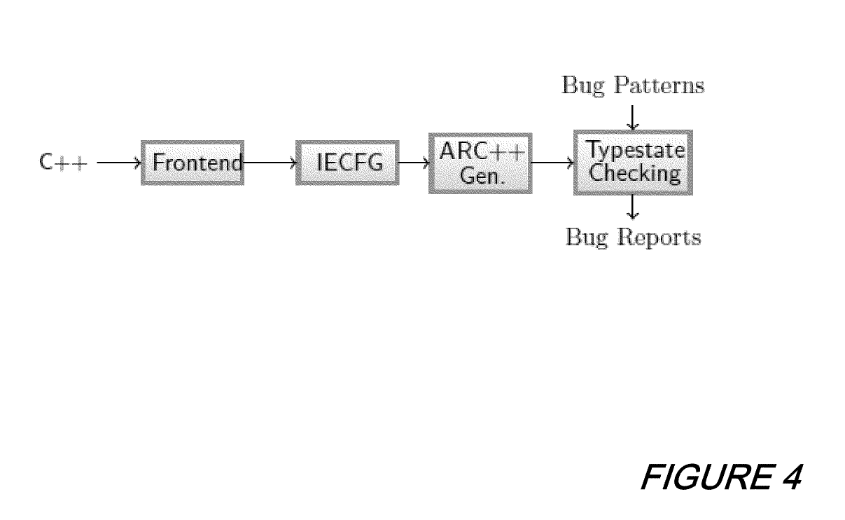

Turning now to FIG. 4, there is shown a schematic block diagram of a tool chain according to the present disclosure. More specifically, and as shown schematically, a C or C++ program as provided as input to a front end for parsing C++ (GIRA) which includes two sub-modules named Simplifier (simplifies complex C++ expressions into simpler ones) and Clarifier (which makes implicit calls explicit). The output of GIRA is CILPP—an internal representation of C++. The GIRA frontend highlights the temporary object usage in a C++ program through full representation in our representation called CILPP. The next step in the chain is where the exception analysis is performed, with the creation of an IECFG after analysis. Then a CILPP abstraction is done resulting in the generation of ARC++. Finally, the IECFG, ARC++, CILPP and Bug Patterns are used together in the analysis module to find any bugs and output bug reports.

The foregoing is to be understood as being in every respect illustrative and exemplary, but not restrictive, and the scope of the invention disclosed herein is not to be determined from the Detailed Description and the attached Appendix, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method of software program analysis comprising the steps of:
by a computer:
automatically generating an abstract representation (ARC++) of a C++ program that captures lifetimes of objects in the program;
performing a lifetime dependency analysis that tracks dependency relationships between lifetimes of different objects to discover bugs;
outputting an indicia of those bugs.

2. The method of claim 1 wherein said ARC++ representation models C++ objects along with any new containers and/or pointers introduced by standard libraries utilized by the C++ program.

3. The method of claim 2 wherein said ARC++ representation makes object creation/destruction, usage, lifetime, and pointer operations explicit in the abstract model thereby providing a basis for static analysis of the C++ program.

4. The method of claim 1 further comprising the step of utilizing a lifetime dependency graph that captures a lifetime relationship between objects such that stale objects are discovered.

5. The method of claim 1 further comprising performing a typestate analysis such that bug patterns are specified as typestate automata over the ARC++ representation.

6. The method of claim 1 further comprising use of access path clusters in an abstract interpretation framework to capture aliasing between objects in the program.

7. The method of claim 1 wherein lifetime dependencies are tracked for temporary objects.

8. The method of claim 1 wherein lifetime dependencies are tracked for internal buffers.

9. A system for performing computer software program analysis, said system comprising a computing device including a processor and a memory coupled to said processor said memory having stored thereon computer executable instructions that upon execution by the processor cause the system to:
automatically generate an abstract representation (ARC++) of a C++ program that captures lifetimes of objects in the program;
perform a lifetime dependency analysis that tracks dependency relationships between lifetimes of different objects to discover bugs; and
output an indicia of those bugs

10. The system of claim 9 wherein said ARC++ representation models C++ objects along with any new containers and/or pointers introduced by standard libraries utilized by the C++ program.

11. The system of claim 10 wherein said ARC++ representation makes object creation/destruction, usage, lifetime, and pointer operations explicit in the abstract model thereby providing a basis for static analysis of the C++ program.

12. The system of claim 9 wherein said computer executable instructions that upon execution by the processor cause the system to utilize a lifetime dependency graph that captures a lifetime relationship between objects such that stale objects are discovered.

13. The system of claim 9 wherein said computer executable instructions that upon execution by the processor cause the system to perform a typestate analysis such that bug patterns are specified as typestate automata over the ARC++ representation.

14. The system of claim 9 wherein said computer executable instructions that upon execution by the processor cause the system to use access path clusters in an abstract interpretation framework to capture aliasing between objects in the program.

15. The system of claim 9 wherein said computer executable instructions that upon execution by the processor cause the system to track lifetime dependencies for temporary objects.

16. The system of claim 9 wherein said computer executable instructions that upon execution by the processor cause the system to track lifetime dependencies for internal buffers.

17. A system for performing computer software program anaylsis, said system comprising a computing device including a processor and a memory coupled to said processor said memory having stored thereon computer executable instructions that upon execution by the processor cause the system to:
receive as input a C++ program;
simplifies any complex C++ expressions contained in the C++ program into simpler ones;
clarifies any implicit calls contained in the C++ program into explicit ones;
generate an internal representation of the C++ program (CILPP);
perform an exception analysis of the CILPP and create an interprocedural exception control flow graph (IECFG);
perform an CILPP abstraction such that an abstract representation of the C++ program (ARC++) is generated;
perform an analysis using the IECFG, ARC++, CILPP along with one or more bug patterns such that bugs in the C++program are identified; and
output an indicia of the identified bugs.
